(19) United States
(12) Patent Application Publication
(10) Pub. No.: US 2010/0165913 A1
(43) Pub. Date: Jul. 1, 2010

(54) METHODS OF TRANSMITTING AND RECEIVING DATA

(75) Inventors: Chee Wei Ang, Singapore (SG); Peng Yong Kong, Singapore (SG)

Correspondence Address: CHOATE, HALL & STEWART LLP, TWO INTERNATIONAL PLACE, BOSTON, MA, 02110, US

(73) Assignee: AGENCY FOR SCIENCE TECHNOLOGY AND RESEARCH, Centros (SG)

(21) Appl. No.: 12/298,533

(22) PCT Filed: Apr. 26, 2007
(86) PCT No.: PCT/SG2007/000119

§ 371 Date: Mar. 18, 2010

Related U.S. Application Data
(60) Provisional application No. 60/794,942, filed on Apr. 26, 2006.

(51) Int. Cl. H04W 40/00

(52) U.S. Cl. 370/328

(57) ABSTRACT

A method of transmitting data from a first communication device to a second communication device, comprising receiving a first signal on a first frequency channel from the second communication device, generating data, wherein the data comprises a reception status indicating whether there is interference on the first frequency channel due to a second signal transmitted by a third communication device, transmitting a third signal on a second frequency channel to the second communication device, wherein the transmission is carried out for a predetermined duration, receiving a fourth signal on the second frequency channel from the second communication device; and transmitting the data generated on the second frequency channel to the second communication device.

The present application claims the benefit of U.S. provisional application 60/794,942 (filed on 26 Apr., 2006), the entire contents of which are incorporated herein by reference for all purposes.

### FIELD OF THE INVENTION

The present invention refers to methods of transmitting and receiving data.

### BACKGROUND OF THE INVENTION

A cognitive radio system operates in frequency channels that have already been allocated or licensed for a specific communication service. In this context, this specific communication service is typically referred to as the incumbent service, and existing users of the incumbent service are known as incumbent users (or primary users).

For example, a cognitive radio system which is designed for providing access to wired networks, such as the Internet, typically adopts a point-to-multipoint (PMP) topology. In the point-to-multipoint topology, the cognitive radio system consists of a basestation (BS) and a few customer premise equipment (CPE). As such, the few customer premise equipment are served by the (single) basestation.

The basestation also typically houses a gateway, which provides a connection from the customer premise equipment served by it to a wired network infrastructure. Meanwhile, the customer premise equipment acts as a network access point within an office or a home, for example.

In general, the cognitive radio system is able to co-exist with the incumbent users in the allocated frequency channels, by ‘opportunistically’ using the portions of the allocated frequency channels which are not used by the incumbent users, perhaps, at certain locations or during specific times.

In order to be able to determine whether a frequency channel is being used by incumbent users, the cognitive radio system regularly performs a process called sensing. During the sensing process, the cognitive radio system periodically detects the presence of signal transmissions by nearby incumbent users, across a range of frequency channels. Accordingly, the status of a range of frequency channels is compiled, on whether a frequency channel is being used by incumbent users or not. In this regard, once the cognitive radio system finds an unused frequency channel, the cognitive radio system may then proceed to operate in this unused frequency channel.

The sensing process does not end here. Even while operating in the unused frequency channel found, the cognitive radio system must continue to periodically sense for the resumption of any signal transmission by the incumbent user, across the same range of frequency channels, including the frequency channel in which it is operating.

Should the cognitive radio system detect that there is a signal transmission by incumbent users in the frequency channel which it is operating in, it must cease its signal transmission in this frequency channel. If there is another unused frequency channel available, the cognitive radio system may continue its operation in this unused frequency channel. Otherwise, the cognitive radio system must cease its operation.

In order for the cognitive radio system to quickly move its operation to another unused frequency channel, as mentioned earlier, it needs to maintain a periodically updated list of unused frequency channels. Therefore, when a move to another unused frequency channel is required, all customer premise equipment can then move to a designated unused frequency channel almost immediately, according to the instructions of the basestation. The said designated unused frequency channel is selected by the basestation from the periodically updated list of unused frequency channels mentioned earlier.

In this context, the sensing for the presence of signal transmissions by incumbent users in the current operating frequency channel of the cognitive radio system is typically referred to as “in-band sensing”. On the other hand, the sensing of all frequency channels other than its current operating frequency channel is typically referred to as “out-of-band sensing”.

In order to achieve a higher probability of detecting the presence of signal transmissions by incumbent users, all components of the cognitive radio system, namely, the basestation and all customer premises equipment, are required to perform the sensing process. In this regard, the customer premise equipment needs to periodically send sensing reports to the basestation, where these sensing reports are consolidated (this consolidation process is also called “fusion”). Based on the consolidated sensing report, the basestation will then decide on whether the cognitive radio system can continue operating in the current frequency channel.

In a conventional method for sending sensing reports, a customer premise equipment is required to send its sensing report to the basestation only on some designated timeslots, which are broadcast periodically by the basestation. In this regard, all customer premise equipment must first be synchronized with the basestation, so that they can determine the designated timeslots for sending their sensing reports. After having determined the designated timeslots for sending their sensing reports, all customer premise equipment will then contend for the use of these designated timeslots in order to transmit their sensing reports.

In the event that a customer premise equipment detects an in-band signal transmission of the incumbent user, the interference from the signal transmission of the incumbent user may cause the customer premise equipment to lose synchronization with the basestation. As a result, this customer premise equipment would then not be able to send its sensing report to the basestation.

Also, there is an additional problem for a customer premise equipment which may have just been switched on within the area of transmission of an incumbent user. This customer premise equipment will scan the frequency channels in order to determine a basestation broadcast. However, due to the interference from the incumbent user's signal transmission, this customer premise equipment would not be able to decode the basestation broadcast. As a result, this customer premise equipment can only make the decision that there is no service available in the area.

The two above mentioned problems occur when a customer premise equipment is located in a region where there is an overlap between the basestation signal transmission coverage and an incumbent user signal transmission coverage. This situation is often referred to as the “hidden incumbent problem”.

A conventional method of solving this problem requires the basestation to continuously broadcast certain information (such as the synchronization signal, for example) in all unused frequency channels, besides its currently used frequency channel. These broadcasts that are made known to all customer premise equipment. According to this conventional method, once a customer premise equipment loses its synchronization with the basestation (i.e., becomes an affected customer premise equipment), it should attempt to scan all the unused frequency channels for the basestation broadcast, in order to restore synchronization with the basestation. The sensing report can then be sent to the basestation using a chosen frequency channel.

However, this conventional method requires the basestation to continuously broadcast information in unused frequency channels, thus taking up unnecessary additional unused frequency channels which can be used by other neighboring cognitive radio systems for data transmission.

The hidden incumbent problem is solved by the methods as defined in the respective independent claims of the present application. The methods provided by the present invention do not require the basestation to continuously broadcast information in unused frequency channels.

### SUMMARY OF THE INVENTION

In a first aspect of the invention, a method of transmitting data from a first communication device to a second communication device is provided. The method provided comprises receiving a first signal on a first frequency channel from the second communication device, generating data, wherein the data comprises a reception status indicating whether there is interference on the first frequency channel due to a second signal transmitted by a third communication device, transmitting a third signal on a second frequency channel to the second communication device, wherein the transmission is carried out for a predetermined duration, receiving a fourth signal on the second frequency channel from the second communication device, and transmitting the data generated on the second frequency channel to the second communication device.

Embodiments of the invention emerge from the dependent claims.

According to one embodiment of the invention, the third signal comprises a multi-tone signal.

In this embodiment, the third signal is not required to carry any data. Accordingly, a simple tone signal may be used. However, a single tone signal is easily generated and detected. In this regard, there is an element of uncertainty as to whether the single tone signal received is generated by communication device belonging to the system or other communication devices.

Furthermore, a single tone signal may also be used for jamming signal transmissions. In this regard, a jamming signal may be wrongly interpreted as being generated by a communication device of the system, and this further add to the above mentioned uncertainty.

Further, the single tone signal generated by a communication device of the system, may end up accidentally jamming signal transmissions of other nearby communication devices. Therefore, in order to avoid all the above mentioned pitfalls, a multi-tone signal is used instead of a simple tone signal.

Additionally, the composition of the multi-tone signal may be also changed periodically in order to further reduce the probability of it being detected wrongly.

According to one embodiment of the invention, the method further comprises synchronizing to the fourth signal received on the second frequency channel from the second communication device. In another embodiment, the fourth signal is a synchronization signal.

As used herein, the term “synchronization signal” refers to a signal used by communication devices in a communication system to facilitate the coordination of events (such as the start time of a frame transmission, for example) in order to operate the communication system in unison.

According to one embodiment of the invention, the second communication device is a basestation.

In a second aspect of the invention, a method of receiving data from a first communication device at a second communication device is provided. The method comprises transmitting a first signal on a first frequency channel, receiving a second signal on one of a plurality of frequency channels, determining the frequency channel from which the second signal is received, transmitting a third signal on the frequency channel determined, and receiving data on the frequency channel determined, wherein the data comprises a reception status indicating whether there is interference on the first frequency channel due to a fourth signal transmitted by a third communication device.

As used herein, the term “a plurality of” refers to at least two or more of the items to which the said term is applied. In this context, the plurality of frequency channels consists of at least two or more frequency channels.

According to one embodiment of the invention, the third signal is a synchronization signal.

According to one embodiment of the invention, the second communication device is a basestation.

In a third aspect of the invention, a method of transmitting data from a first communication device to a second communication device is provided. The method comprises receiving a first signal on a first frequency channel from the second communication device, generating data, wherein the data comprises a reception status indicating whether there is interference on the first frequency channel due to a second signal transmitted by a third communication device, and transmitting a third signal on a second frequency channel to the second communication device, wherein the third signal comprises the data generated, and wherein the transmission is carried out at predetermined intervals for a predetermined number of times.

According to one embodiment of the invention, the third signal further comprises a preamble.

As used herein, the term “preamble” refers to an introduction to a message or a message header. In this context, for example, in one embodiment, the preamble is a pseudo-random sequence. In another embodiment, the preamble is a Gold sequence.

According to one embodiment of the invention, the second communication device is a basestation.

In a fourth aspect of the invention, a method of transmitting data from a first communication device to a second communication device is provided. The method comprises receiving a first signal on a first frequency channel from the second communication device, generating data, wherein the data comprises a reception status indicating whether there is interference on the first frequency channel due to a second signal transmitted by a third communication device, and transmitting a third signal on the first frequency channel to the second communication device, at a transmission power level at least substantially near the maximum transmission power level, wherein the third signal comprises the data generated.

According to one embodiment of the invention, the transmission of the third signal is carried out for a predetermined duration.

According to one embodiment of the invention, the third signal further comprises a preamble. For example, in one embodiment, the preamble is a pseudo-random sequence. In another embodiment, the preamble is a Gold sequence.

According to one embodiment of the invention, the second communication device is a basestation.

In a fifth aspect of the invention, a method of transmitting data from a first communication device to a second communication device is provided. The method comprises receiving a first signal on a first frequency channel from the second communication device, generating data, wherein the data comprises a reception status indicating whether there is interference on the first frequency channel due to a second signal transmitted by a third communication device, and transmitting a third signal on the first frequency channel to the second communication device, wherein the third signal comprises the data generated, and wherein the transmission is carried out for a predetermined duration.

According to one embodiment of the invention, the third signal further comprises a preamble. For example, in one embodiment, the preamble is a pseudo-random sequence. In another embodiment, the preamble is a Gold sequence.

According to one embodiment of the invention, the second communication device is a basestation.

In a sixth aspect of the invention, a method of receiving data from a first communication device at a second communication device is provided. The method comprises transmitting a first signal on a first frequency channel, determining a second signal from a plurality of frequency channels, wherein the second signal includes data, and wherein the data comprises a reception status indicating whether there is interference on the first frequency channel due to a third signal transmitted by a third communication device, and deriving the data from the second signal determined.

According to one embodiment of the invention, the second signal further comprises a preamble. For example, in one embodiment, the preamble is a pseudo-random sequence. In another embodiment, the preamble is a Gold sequence.

According to one embodiment of the invention, the second communication device is a basestation.

In a seventh aspect of the invention, a method of transmitting data from a first communication device to a second communication device is provided. The method comprises receiving a first signal on a first frequency channel from the second communication device, generating data, wherein the data comprises a reception status indicating whether there is interference on the first frequency channel due to a second signal transmitted by a third communication device, determining a third signal on the second frequency channel from the second communication device, initiating the setting up of a communication connection with the second communication device on a second frequency channel, determining a time interval for transmission allocated by the second communication device, and transmitting the data generated on the second frequency channel to the second communication device, at a time interval allocated.

According to one embodiment of the invention, the method provided further comprises synchronizing to the third signal received on the second frequency channel from the second communication device. In one embodiment, the third signal is a synchronization signal.

According to one embodiment of the invention, the second communication device is a basestation.

In an eighth aspect of the invention, a method of receiving data is provided. The method comprises transmitting a first signal on a first frequency channel, transmitting a second signal on a plurality of second frequency channels, setting up a communication connection initiated by a first communication device on one of the plurality of second frequency channels determined by the first communication device, allocating a time interval for transmission by the first communication device on the frequency channel determined by the first communication device, wherein the allocation of the time interval for transmission is performed by the second communication device, and receiving data from the first communication device at the time interval allocated on the frequency channel determined by the first communication device, wherein the data comprises a reception status indicating whether there is interference on the first frequency channel due to a third signal transmitted by a third communication device.

According to one embodiment of the invention, the second signal is a synchronization signal.

According to one embodiment of the invention, the second communication device is a basestation.

The embodiments which are described in the context of the methods of transmitting data are analogously valid for the methods of receiving data.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block diagram with a first communication system co-existing with a second communication system for illustrating the problem of hidden incumbents, according to one embodiment of the invention.

FIG. 2 shows another block diagram with a first communication system co-existing with a second communication system for illustrating the problem of hidden incumbents, according to one embodiment of the invention.

FIG. 3 shows a flow diagram describing a first embodiment of transmitting data and receiving data, according to one embodiment of the invention.

FIG. 4 shows a flow chart describing a first embodiment of transmitting data, according to one embodiment of the invention.

FIG. 5 shows a flow chart describing a first embodiment of receiving data, according to one embodiment of the invention.

FIG. 6 shows a block diagram of an example signal used in one embodiment of the invention.

FIG. 7 shows a flow diagram describing a second embodiment of transmitting data and receiving data, according to one embodiment of the invention.

FIG. 8 shows an example beacon message used in one embodiment of the invention.

FIG. 9 shows a flow diagram describing a third embodiment of transmitting data and receiving data, according to one embodiment of the invention.

FIG. 10 shows a flow diagram describing a fourth embodiment of transmitting data and receiving data, according to one embodiment of the invention.

FIG. 11 shows a flow chart describing a second embodiment, a third embodiment and a fourth embodiment of transmitting data, according to one embodiment of the invention.

FIG. 12 shows a flow chart describing a second embodiment, a third embodiment and a fourth embodiment of receiving data, according to one embodiment of the invention.

FIG. 13 shows a flow diagram describing a fifth embodiment of transmitting data and receiving data, according to one embodiment of the invention.

### DETAILED DESCRIPTION OF THE INVENTION

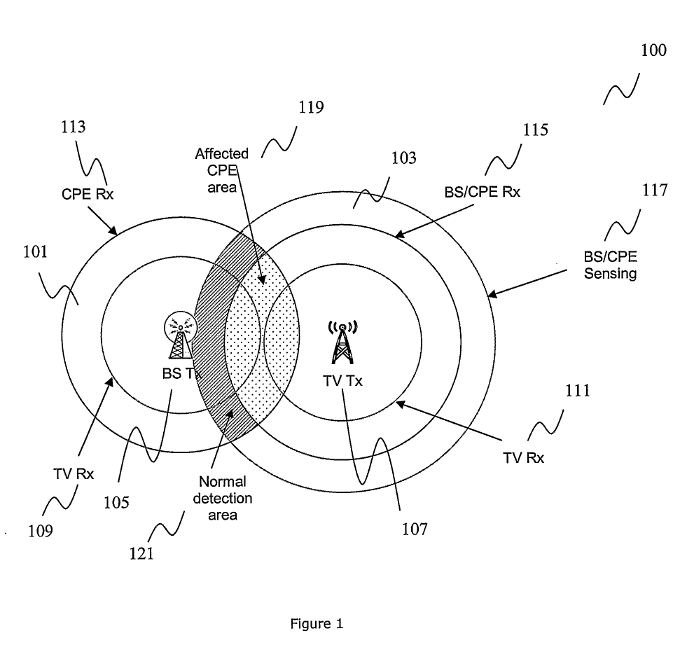

FIG. 1 shows block diagram 100 with a first communication system 101 co-existing with a second communication system 103 for illustrating the problem of hidden incumbents, according to one embodiment of the invention.

The first communication system 101 may be, for example, a cognitive radio system. Using the cognitive radio system as an example, the first communication system 101 comprises at least one first communication device and a second communication device.

In this illustration, the first communication device may be, but is not limited to, a customer premise equipment (CPE), for example. The second communication device may be, but is not limited to, a basestation (BS) 105, for example.

The second communication system 103 may be, for example, a television (TV) broadcast system. Accordingly, the second communication system 103 includes a third communication device, and at least one receiver in the vicinity of the third communication device. In this illustration, the third communication device may be, but is not limited to, an incumbent TV transmission station 107, for example.

In this illustrative example, the TV broadcast system may be considered as the incumbent user, since the frequency channels of interest have been allocated for TV broadcast services. Accordingly, the cognitive radio system may use one or more frequency channels within the frequency channels of interest only when the TV broadcast system is not using them.

In order to analyze the co-existence of the two communication systems, the term “reachability contour” will be used herein. The term “reachability contour” may be defined as follows.

It is known that a receiver can receive a signal, provided the power of the signal received is higher than the sensitivity of the receiver. In this regard, the “reachability” (which is a measure of distance) of a signal transmission depends on the signal transmission power and the receiver sensitivity (for example, in free space, two-ray or log-normal loss models). In other words, a receiver can receive a signal transmission, provided it is within the “reachability contour” of the transmitter of the signal.

In this context, as used herein, the term “receive” refers to the reception of a signal, whereby the data derived from the received signal has a probability of error below a pre-determined error-rate.

It is known that different types of communication devices have different receiver sensitivity. Therefore, for the same transmitted signal, since customer premise equipment and incumbent receivers (such as TV receivers) have different receiver sensitivity, their respective “Teachability contours” will be different.

Additionally, the customer premise equipment and/or the basestation of a cognitive radio system may have two receivers, for example, one for data reception and another one for sensing. Ideally, the sensing receiver should be designed with higher sensitivity than the data reception receiver, in order to be able to detect incumbent users which are further away.

In the illustration shown in FIG. 1, it is assumed that the receiver sensitivity of the sensing receiver is higher than that of the data reception receiver, and that the receiver sensitivity of the data reception receiver is higher than that of the TV receiver. Accordingly, the reachability contour for the sensing receiver is larger than that for the data reception receiver, and that the reachability contour for the data reception receiver is higher than that for the TV receiver.

In FIG. 1, the reachability contour for the TV receiver with respect to the basestation 105 is denoted by “TV Rx” and labeled as 109. Similarly, the reachability contour for the TV receiver with respect to the TV transmission station 107 is denoted by “TV Rx” and labeled as 111.

The reachability contour for the data reception receiver with respect to the basestation 105 is denoted by “CPE Rx” and labeled as 113. Similarly, the reachability contour for the data reception receiver with respect to the TV transmission station 107 is denoted by “BS/CPE Rx” and labeled as 115. It should be noted that it is also assumed here that the data reception receivers of the customer premise equipment and the basestation have the same receiver sensitivity and hence the same reachability contour.

Finally, the reachability contour for the sensing receiver with respect to the TV transmission station 107 is denoted by “BS/CPE Sensing” and labeled as 117. In this regard, there is no “CPE Sensing” reachability contour drawn with respect to the basestation 105, since the customer premise equipment typically does not perform the sensing process for the basestation 105 which it is associated with.

As a side note, if the basestation 105 is located close enough to the TV transmission station 107, it can directly sense the presence of signal transmissions from the TV transmission station 107. Accordingly, the hidden incumbent problem described earlier would not happen. Therefore, in order to illustrate the hidden incumbent problem, the basestation 105 should be located just outside the “BS/CPE Sensing” reachability contour 117.

For example, in this illustration, a TV receiver inside the “TV Rx” reachability contour 111 around the TV transmitting station 107 does not suffer any interference from the signals transmitted from the basestation 105, because it is not inside the “TV Rx” reachability contour 109 around the basestation 105. This means that if the TV is in an area inside “TV Rx” reachability contour 111 as well as inside “TV Rx” reachability contour 109 (an area where the two reachability contours overlap each other), only then will the TV receiver suffer interference from the basestation 105. In this illustration, the said overlap area does not exist.

However, in this illustration, there is an area whereby the “CPE Rx” contours overlap each other (the “dotted” area), called the affected CPE area 119. This means that customer premise equipment inside the overlap region will suffer interference from the signals transmitted by the TV transmission 107. Therefore, the affected customer premise equipment may lose synchronization with the basestation 105 and thus may not be able to receive further signals from the basestation 105.

As a further example, if there is a customer premise equipment located inside the overlap area (the “slope-shaded” area) of the “CPE Rx” reachability contour 113 around the basestation 105 and the “CPE Sensing” reachability contour 117 around the TV transmission station 107, but outside the “BS/CPE Rx” reachability contour 115 around the TV transmission station 107, this customer premise equipment will be able to detect the TV signal transmissions and report the presence of the incumbent TV transmission station 107 to the basestation 105. This is called as the normal detection area, whereby the incumbent TV transmission station 107 can be detected and reported accordingly to the basestation 105.

It should be noted that the transmission by the customer premise equipment to send the report to the basestation 105 will cause interference to some TV receivers inside the “TV Rx” reachability contour 111 around the TV transmitter 107. However, since the said transmission of the report takes only a short time, the interference caused is also only for a short time.

In this regard, it is still necessary for the basestation 105 to change its operating frequency channel even though the signal transmission of the basestation 105 does not cause interference to the TV receivers. This is because the signal transmissions from the customer premise equipment in the normal detection area 121 and the affected CPE area 119 can still cause interference to the TV receivers.

As a side remark, it should be noted that customer premise equipment may be equipped with directional antennas. Accordingly, the reachability contour of the customer premise equipment may be not circular in shape, and will probably take a shape similar to that of the directional antenna gain pattern.

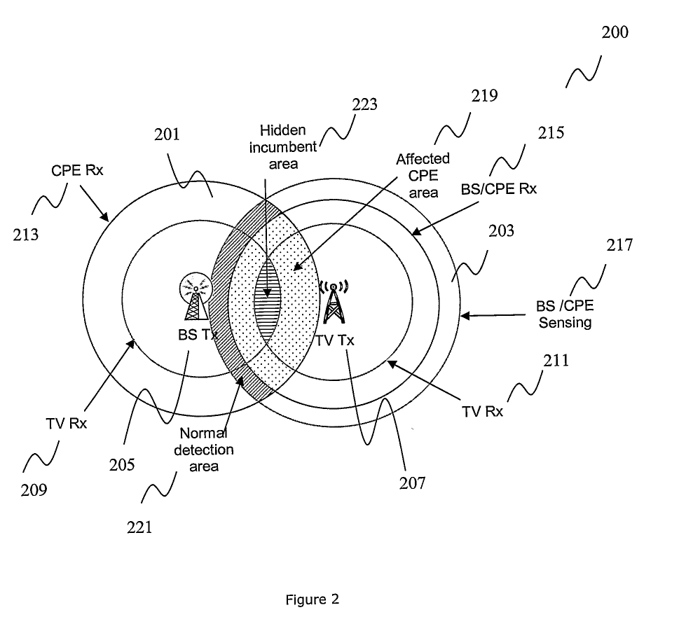

FIG. 2 shows another block diagram 200 with a first communication system 201 co-existing with a second communication system 203 for illustrating the problem of hidden incumbents, according to one embodiment of the invention.

Similar to FIG. 1, the first communication system 201 may be, for example, a cognitive radio system. Using the cognitive radio system as an example, the first communication system 201 comprises at least one first communication device and a second communication device.

In this illustration, the first communication device may be, but is not limited to, a customer premise equipment (CPE), for example. The second communication device may be, but is not limited to, a basestation (BS) 205, for example.

The second communication system 203 may be, for example, a television (TV) broadcast system. Accordingly, the second communication system 203 includes a third communication device, and at least one receiver in the vicinity of the third communication device. In this illustration, the third communication device may be, but is not limited to, an incumbent TV transmission station 207, for example.

For the sake of clarity, a corresponding label is used for similar items in FIGS. 1 and 2. For example, an item labeled 205 in FIG. 2 corresponds to the item labeled as 105 in FIG. 1.

Comparing the block diagrams of FIG. 1 and FIG. 2, it can be seen that both block diagrams have the same items, except that the block diagram in FIG. 2 has an additional item called the hidden incumbent area 223. This is the area where the two “TV Rx” reachability contours (209 and 211) overlap each other.

In this illustrative example, it can be seen that the signal transmissions from the basestation 205 will cause interference to TV receivers within the hidden incumbent area 223, and yet the basestation 205 is not aware of the presence of the nearby TV transmission station 207. In this regard, the signal transmissions from the basestation 205 would cause continuous interference to the said TV receivers. In essence, this is the hidden incumbent problem.

It should also be noted that only the customer premise equipment in the normal detection area 221, are able to detect the incumbent user and report accordingly to the basestation 205. If there is no customer premise equipment inside this normal detection area 221, then with the conventional methods, incumbent detection and reporting is no longer possible.

While there may be other customer premise equipment which are able to detect the signal transmission of the TV transmission station 207, such as those in the affected CPE area 219, however, these customer premise equipment suffers interference from the signals transmitted by the TV transmission station 207. Therefore, they may lose synchronization with the basestation 205, and thus be unable to send their respective sensing reports to the basestation 205. As mentioned earlier, such customer premise equipment are known as affected customer premise equipment.

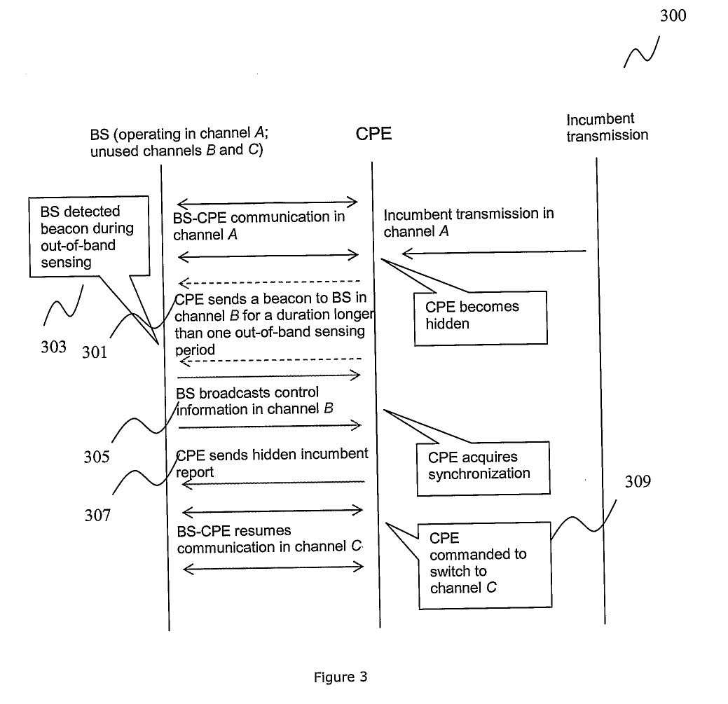

FIG. 3 shows a flow diagram 300 describing a first embodiment of transmitting data and receiving data, according to one embodiment of the invention.

In the scenario illustrated by FIG. 3, a cognitive radio system, comprising a first communication device and a second communication device, operates in frequency channel A, with two frequency channels known (to the cognitive radio system) to be unused, B and C. Accordingly, the basestation and the customer premise equipment carry out their communication and data transmission over frequency channel A.

At one point in time, a third communication device begins its signal transmission in frequency channel A. Due to the interference resulting from the signal transmitted by the third communication device, the first communication device loses synchronization with the second communication device, and is thus an affected communication device.

Alternatively, it may also be that when the first communication device is switched on, it discovers that there is no broadcast from the second communication device at all. Accordingly, the first communication device is not able to synchronize to the second communication device, and thus can conclude that it may be an affected communication device.

In this illustration, the first communication device may be, but is not limited to, a customer premise equipment (CPE), for example. The second communication device may be, but is not limited to, a basestation (BS), for example. The third communication device may be, but is not limited to, an incumbent user transmission station, for example.

In this illustrative example of an embodiment of the invention, upon realizing that it is an affected customer premise equipment, the customer premise equipment selects a frequency channel from a list of unused frequency channels (maintained by the customer premise equipment). In the illustration shown in FIG. 3, frequency channel B is selected.

The customer premise equipment then generates a sensing report, and proceeds to perform a series of signal transmissions in order to regain synchronization with the basestation, before sending the sensing report to it.

In this regard, and as used herein, the sensing report may simply be a set of data which includes information on the frequency channel affected by the signal transmissions of the incumbent user transmission station. The sensing report may also include additional information such as the unused frequency channels (for example, by an incumbent transmission station) obtained through the sensing process performed by the customer premise equipment.

In step 301, the customer premise equipment transmits a beacon signal on frequency channel B. The beacon signal will be described in more detail, in relation to FIG. 6.

The beacon signal is transmitted continuously for a predetermined duration. The predetermined duration may be a duration which is at least longer than one out-of-band sensing period.

When the basestation detects the beacon signal during its out-of-band sensing process, as shown in step 303, the basestation recognizes that there is an affected customer premise equipment somewhere within its vicinity. The basestation then proceeds to broadcast control information, including a synchronization signal, on the frequency channel from where the beacon signal is detected (in this case, this frequency channel is frequency channel B), in step 305.

When the affected customer premise equipment detects the broadcast of the basestation on frequency channel B, it attempts to synchronize with the basestation using the synchronization signal broadcasted. Once synchronization with the basestation is achieved, the customer premise equipment then sends the sensing report generated to the basestation, in step 307.

After successfully receiving the sensing report and determining which frequency channel is affected by the incumbent user transmission station's signal transmissions, the basestation selects an unused frequency channel from a list of unused frequency channels maintained at the basestation. In the illustration shown in FIG. 3, frequency channel C is selected.

Next, in order to switch all customer premise equipment operating in the current frequency channel to the selected frequency channel, (in step 309) the basestation broadcasts a frequency channel switch command, for example, in the current frequency channel where it is operating in (frequency channel A), as well as the frequency channel on which the beacon signal was detected (frequency channel B). Subsequently, this cognitive radio system continues its operation on frequency channel C.

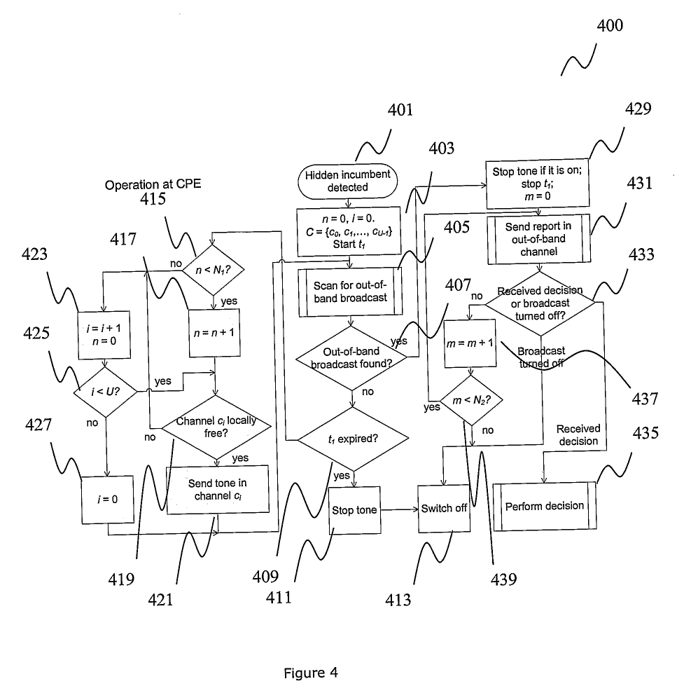

FIG. 4 shows a flow chart 400 describing a first embodiment of transmitting data, according to one embodiment of the invention.

In step 401, the customer premise equipment performs its sensing process. During the sensing process, the customer premise equipment detects a signal transmission by an incumbent user transmission station.

The customer premise equipment then performs an initialization to set the index to the number of beacon signal transmission, n, and the index to the frequency channel on which the beacon signal is transmitted, i, to the value of 0 (in step 403). In this regard, a timer, t₁, is also started in step 403.

Additionally, in step 403, the list of frequency channels to transmit the beacon signal on is the list of unused frequency channels, which is either obtained through the broadcast information in the signal transmissions received from the basestation earlier, or from the sensing process it had carried out earlier, for example. In this regard, the number of frequency channels to transmit on, U, according to the number of frequency channels on the list of unused frequency channels.

Next, the customer premise equipment generates the sensing report and proceeds to step 405, where it listens to the frequency channel (which is selected for transmitting the beacon signal on) for a broadcast signal from the basestation.

If the broadcast signal from the basestation is not detected in step 407, the customer premise equipment then determines whether the timer, t₁, has expired or not.

If it is determined that the timer, t₁, has expired in step 409, the customer premise equipment stops the transmission of the beacon signal (in step 411) and then switches off (in step 413).

As a side remark, as mentioned earlier, the beacon signal will be described in more detail, in relation to FIG. 6.

With regard to step 409, if it is determined that the timer, t₁, has not expired in step 409, the customer premise equipment proceeds to step 415, where it determines whether the index to the number of beacon signal transmission, n, is less than a predetermined maximum number of beacon signal transmission, N₁, or not.

If it is determined that the index to the number of beacon signal transmission, n, is less than a predetermined maximum number of beacon signal transmission, N₁, in step 415, the index to the number of beacon signal transmission, n, is incremented by 1 (in step 417).

As a side note, step 415 is basically used to determine whether the predetermined number of beacon signal transmissions on a selected frequency channel had been reached. If the predetermined number of beacon signal transmissions had been reached, then the next beacon signal should be transmitted on the next frequency channel on the list of frequency channels to transmit on, if necessary.

Next, the customer premise equipment determines whether the selected frequency channel (from the list of frequency channels to transmit the beacon signal on) is free locally or not.

In this context, the term “free locally” refers to whether the selected frequency channel is still unused presently. It may be the case that from the time the selected frequency channel was determined to be unused to the present time, an incumbent user may have begun transmitting in this selected frequency channel. Accordingly, this additional step is performed in order to avoid a signal transmission which will unnecessarily cause interference to the incumbent user, if present, on the selected frequency channel. As such, this additional step is only an optional step in this embodiment of the invention.

Further, in step 419, if it is determined that the selected frequency channel is free locally, the beacon signal is transmitted on the selected frequency channel in step 421. Following which, the customer premise equipment proceeds back to step 405 for further processing.

On the other hand, if it is determined that the selected frequency channel is not free locally in step 419, the customer premise equipment proceeds to step 423, where the index to the frequency channel on which the beacon signal is transmitted, i, is incremented by 1 and the index to the number of beacon signal transmission, n, is reset to the value of 0.

In other words, the next frequency channel on the list of frequency channels to transmit on is selected for subsequent beacon signal transmissions, and the number of beacon signal transmissions on this frequency channel is initialized to N₁ (since the index n will eventually count up to N₁).

Next, if it is determined in step 425 that the index to the frequency channel on which the beacon signal is transmitted, i, is less than the maximum number of frequency channels to transmit on, U, then the customer premise equipment proceeds back to step 419 for further processing. Basically, a further check is performed this newly selected frequency channel to ensure that it is free locally before a beacon signal is transmitted on it.

If it is determined in step 425 that the index to the frequency channel on which the beacon signal is transmitted, i, is not less than the maximum number of frequency channels to transmit on, U, then the customer premise equipment proceeds to step 427, where the index to the frequency channel on which the beacon signal is transmitted, i, is reset to the value of 0. Following which, the customer premise equipment proceeds to step 405 for further processing.

This means that the selected frequency channel is the first frequency channel on the list of frequency channels to transmit on. As long as the timer, t₁, has not expired yet, the customer premise equipment would transmit the beacon signal again in the unused frequency channels, which it had transmitted on previously.

As a side note, step 425 is basically used to determine whether the maximum number of frequency channels to transmit the beacon signals on had been reached. If the maximum number of frequency channels to transmit the beacon signals on had not been reached yet, the next beacon signal should then be transmitted on the next frequency channel on the list of frequency channels to transmit on.

Returning again to step 407, if the broadcast signal from the basestation is detected, the customer premise equipment then proceeds to step 429, where it stops the transmission of the beacon signal, if the transmission of the beacon signal had not been stopped previously. Further, in step 429, the timer, t₁, is also stopped and the index to the number of sensing report transmissions, m, is set to the value of 0.

Additionally, the broadcast signal from the basestation includes control information as well as a synchronization signal. The customer premise equipment uses the synchronization signal to regain synchronization with the basestation, after which it may then transmit the sensing report to the basestation.

In step 431, the customer premise equipment transmits a sensing report to the basestation on the frequency channel, on which the broadcast signal from the basestation was received earlier.

In step 433, the customer premise equipment next listens for a signal transmission from the basestation in response to the sensing report transmitted, on the same frequency channel on which the beacon signal had been transmitted earlier.

If a signal is received from the basestation and the signal contains a decision (or a command) of the basestation in step 433, the customer premise equipment then performs the necessary tasks according to the decision of the basestation (in step 435).

Further, in step 433, if it is determined that the broadcast signal from the basestation detected earlier has been turned off, and since the customer premise equipment has yet to receive any instruction on the decision of the basestation, it then switches off (in step 413).

If no signal is received from the basestation in step 433, the customer premise equipment then proceeds to step 437, where the index to the number of sensing report transmissions, m, is increased by 1.

In step 439, if the index to the number of sensing report transmissions, m, is determined to be not less than the predetermined number of sensing report transmissions, N₂, the customer premise equipment proceeds to step 413, where it switches off.

On the other hand, if the index to the number of sensing report transmissions, m, is determined to be less than the predetermined number of sensing report transmissions, N₂, in step 439, the customer premise equipment proceeds to step 431 for further processing.

Additionally, it can be seen that the customer premise equipment transmits N₁ beacon signals on each unused frequency channel, when available. The purpose of transmitting N₁ beacon signals on each unused frequency channel is to ensure that in each unused frequency channel, the basestation has the opportunity to detect one of these beacon signals during its out-of-band sensing periods. With subsequent interactions and signal transmissions, the basestation is then able to proceed to eventually receive the sensing report of the customer premise equipment.

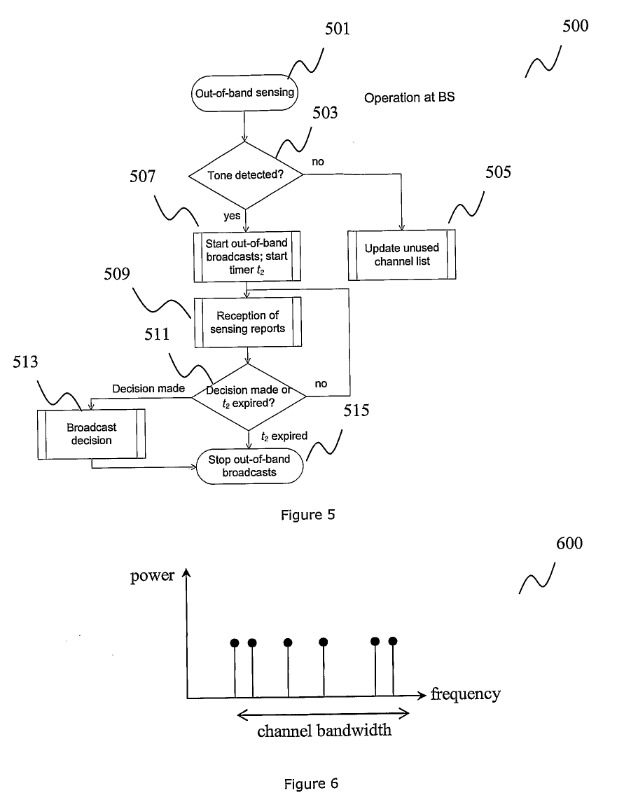

FIG. 5 shows a flow chart 500 describing a first embodiment of receiving data, according to one embodiment of the invention.

In step 501, the basestation performs an out-of-band sensing process. If a multi-tone beacon signal is not detected in step 503, then the basestation updates its list of unused frequency channels (in step 505) according to the information obtained during the out-of-band sensing process.

If a multi-tone beacon signal is detected in step 503, the basestation starts a timer t₂, and starts its out-of-band broadcasts of control information on the frequency channel where the multi-tone beacon signal was detected earlier (step 507). In the meantime, the basestation also listens to one of the out-of-band frequency channels (the frequency channel where the multi-tone beacon signal was detected earlier), in order to receive the sensing report, according to step 509.

In the case where a sensing report is received, the basestation then makes a decision on which unused frequency channel to move the operation of the cognitive radio system to (step 511). If a decision is made, the basestation then broadcasts the decision made on the current operating frequency channel as well as the out-of-band frequency channel, where the multi-tone beacon signal was detected earlier, in step 513. The basestation then stops the broadcast of control information over the out-of-band frequency channel where the multi-tone beacon signal was earlier detected (step 515).

In this regard, if a sensing report is not received, then the basestation continues with step 509, until a sensing report is received or until the timer t₂ expires. If the timer t₂ expires, then the basestation stops the broadcast of control information over the out-of-band frequency channel where the multi-tone beacon signal was earlier detected (step 515).

FIG. 6 shows a diagram of an example signal used in one embodiment of the invention.

In this embodiment, since the method of transmitting the sensing report is a synchronous method, the beacon signal is not required to carry any data. Accordingly, a simple tone signal may be used.

However, a single tone signal is easily generated and detected. In this regard, there is an element of uncertainty as to whether the single tone signal received is generated by a communication device belonging to the cognitive radio system or by another communication device.

Furthermore, a single tone signal may also be used for jamming signal transmissions. In this regard, a jamming signal may be wrongly interpreted as being generated by a communication device of the system, and this further add to the above mentioned uncertainty.

Further, the single tone signal generated by a communication device of the system, may end up accidentally jamming signal transmissions of other nearby communication devices. Therefore, in order to avoid all the above mentioned pitfalls, a multi-tone signal is used in one embodiment instead of a simple tone signal.

Additionally, the composition of the multi-tone signal may be also changed periodically in order to further reduce the probability of it being detected wrongly. The multi-tone beacon signal shown in FIG. 6 consists of a plurality of tone signals spanning an entire frequency channel bandwidth. The multi-tone beacon signal is defined by only the presence of tone signals at predetermined frequencies. In this regard, the power level of the tone signals is not of particular relevance to the multi-tone beacon signal, as long as the power level is above the detection threshold of the basestation receiver, for example.

As mentioned earlier, the term “a plurality of” refers to at least two or more of the items to which the said term is applied. In this context, the multi-tone signal consists of at least two or more tone signals.

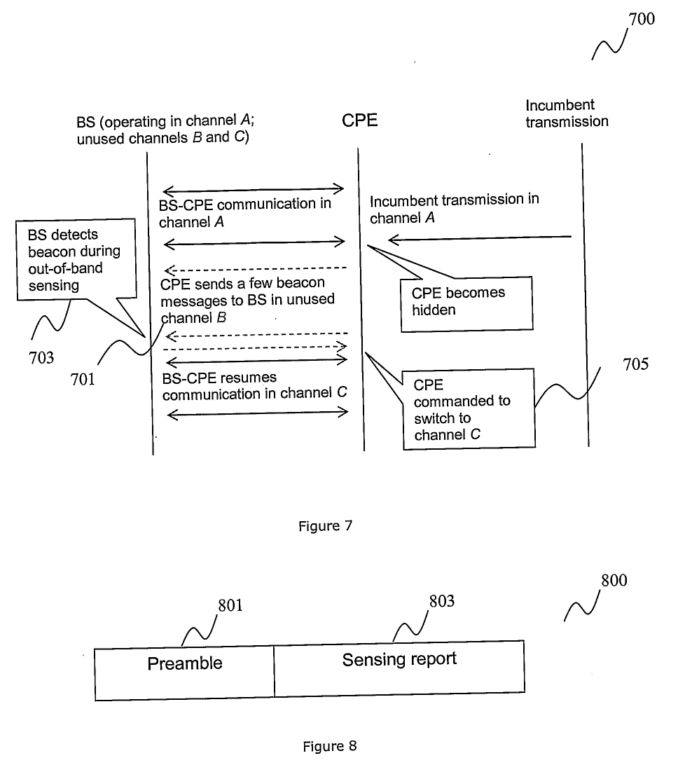

FIG. 7 shows a flow diagram 700 describing a second embodiment of transmitting data and receiving data, according to one embodiment of the invention.

The scenario illustrated by FIG. 7 is similar to that illustrated in FIG. 3, whereby a cognitive radio system, comprising a first communication device and a second communication device, operates on frequency channel A, with two frequency channels known to be unused, B and C, and the first communication device becomes affected due to the signal transmission of a nearby third communication device.

In this illustration, the first communication device may be, but is not limited to, a customer premise equipment, for example. The second communication device may be, but is not limited to, a basestation, for example. The third communication device may be, but is not limited to, an incumbent user transmission station, for example.

In this illustrative example of an embodiment of the invention, upon realizing that it is an affected customer premise equipment, the customer premise equipment first determines a list of the unused frequency channels.

In this regard, the customer premise equipment may choose to determine the list of the unused frequency channels using information it already has. In this case, the list of unused frequency channels would have only 2 frequency channels, namely, frequency channel B and frequency channel C.

Alternatively, the customer premise equipment may choose to scan all frequency channels within the frequency channels of interest, in order to determine which ones are unused. Accordingly, the list of unused frequency channels determined using this approach typically has more unused frequency channels, as compared to the earlier mentioned approach.

In the next step, regardless of which of the two approaches mentioned above is used, the customer premise equipment selects a frequency channel from the list of unused frequency channels. In the illustration shown in FIG. 7, frequency channel B is selected.

Next, in step 701, the customer premise equipment generates a sensing report and then transmits it on frequency channel B as beacon messages. The beacon messages will be described in more detail, in relation to FIG. 8.

As a side remark, the beacon message used here may be different from the beacon signal used in the method illustrated in FIG. 3, for example. The beacon signal used in the method illustrated in FIG. 3 does not include any data, whereas the beacon message used here includes the sensing report.

In step 701, the beacon messages are sent out periodically for N₁ number of times. If there is no response from the basestation on frequency channel B after N₁ beacon messages have been sent on the selected frequency channel, another frequency channel is then selected from the list of unused frequency channels and N₁ beacon messages are sent again on the selected frequency channel. This process is repeated until a response is received from the basestation on the selected frequency channel.

In the event that there is no basestation within its transmission range, the customer premise equipment will not receive any response. Accordingly, the customer premise equipment then stops all transmission after repeating the above mentioned process for N₂ number of tries, for example.

On the basestation's side, if the basestation is within range of the beacon message transmission, the basestation will be able to detect the beacon message during its out-of-band sensing process. Upon the detection of the beacon message in step 703, the basestation recognizes that there is an affected customer premise equipment somewhere within its vicinity. The basestation then proceeds to decode the beacon message in order to find out which frequency channel is affected by the incumbent user transmission station's signal transmissions. In the event that the basestation is unable to decode the present beacon message, it will wait and then try to decode the next beacon message.

After successfully decoding the beacon message, the basestation selects an unused frequency channel from a list of unused frequency channels maintained at the basestation. In the illustration shown in FIG. 7, frequency channel C is selected.

Next, in order to switch all customer premise equipment operating in the current frequency channel to the selected frequency channel, (in step 705) the basestation broadcasts a frequency channel switch command, for example, in the current frequency channel where it is operating in (frequency channel A), as well as the frequency channel on which the beacon message was detected (frequency channel B). Subsequently, this cognitive radio system continues its operation on frequency channel C.

FIG. 8 shows an example beacon message 800 used in one embodiment of the invention.

The example beacon message 800 comprises a preamble 801 and a sensing report 803.

In order to make the beacon message detectable despite the presence of other communication signals and noise, the beacon message may be designed such that the preamble 801 has some deterministic properties. For example, the preamble 801 may be, but is not limited to, a pseudo-random sequence, a Barker code or a pseudo-noise sequence (such as a Gold code, a Kasami code, for example).

With regard to the sensing report, the generation of the sensing report 803 has been discussed earlier in relation to FIGS. 3 and 7, for example.

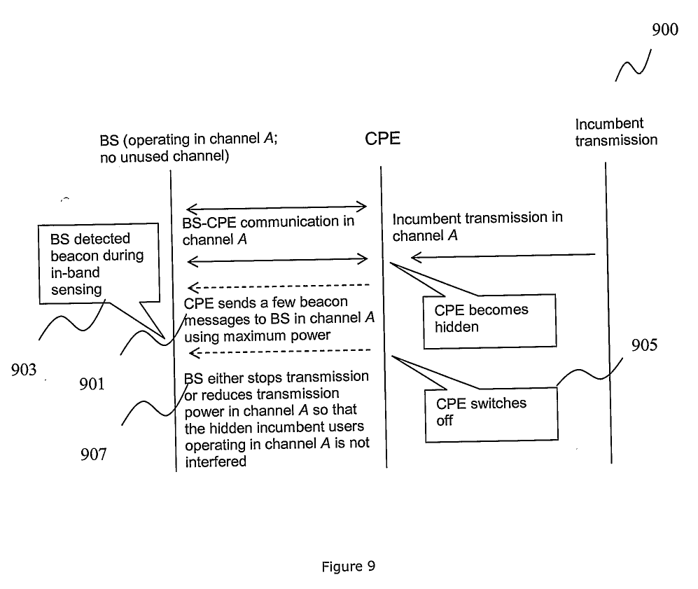

FIG. 9 shows a flow diagram 900 describing a third embodiment of transmitting data and receiving data, according to one embodiment of the invention.

In the scenario illustrated by FIG. 9, a cognitive radio system, comprising a first communication device and a second communication device, operates in frequency channel A. However, it is known that there are no other unused frequency channels (unlike the illustrations shown in FIG. 3 or 7). Accordingly, the first communication device and the second communication device carry out their communication and data transmission over frequency channel A.

Similar to the illustration in FIG. 3, at one point in time, a third communication device begins its signal transmission in frequency channel A. Due to the interference resulting from the signal transmitted by the third communication device, the first communication device loses synchronization with the second communication device, and is thus an affected communication device.

Alternatively, similar to the illustration in FIG. 7, it may also be that when the first communication device is switched on, it discovers that there is no broadcast from the second communication device at all. Accordingly, the first communication device is not able to synchronize to the second communication device, and may thus conclude that it may be an affected communication device.

In this illustration, the first communication device may be, but is not limited to, a customer premise equipment, for example. The second communication device may be, but is not limited to, a basestation, for example. The third communication device may be, but is not limited to, an incumbent user transmission station, for example.

In this illustrative example of an embodiment of the invention, upon realizing that it is an affected customer premise equipment, the customer premise equipment first determines a list of the unused frequency channels, and finds that there is no unused frequency channels.

Next, in step 901, the customer premise equipment generates a sensing report and then transmits it on its last known operating frequency channel, which in this case is frequency channel A, as beacon messages. The beacon messages described earlier in relation to FIG. 8, may also be used in this embodiment of the invention.

Additionally, in this embodiment, the transmission of the beacon messages is carried at a power level at least substantially near the maximum transmission power level of the customer premise equipment. In this regard, it is noted that the transmission of the beacon messages at such a high transmission power level will inevitably cause collisions with ongoing data transmissions within the cognitive radio system, as well as causing interference to incumbent user devices. However, in view of the basis of operating a cognitive radio system, the prevention of further interference to the incumbent user devices is more important. Accordingly, the transmission of the beacon messages by the first communication device in this case may be considered as a measure of last resort.

In step 901, the customer premise equipment transmits the beacon messages continuously at this high transmission power level, for a predetermined duration. In view of the reasons mentioned above, the predetermined duration should be as short as possible. Nevertheless, the predetermined duration should be at least slightly longer than the periodic in-band sensing interval of the basestation, so that the basestation is able to detect the beacon in at least one of the in-band sensing intervals.

Additionally, in step 903, after transmitting the beacon message for the predetermined duration, the customer premise equipment then either stops all transmissions or switches off.

On the basestation's side, since the beacon message is sent in the operating frequency channel, the basestation will detect this beacon during its in-band sensing, as shown in step 905.

In step 907, as there is no more unused frequency channels, the second communication device may make a decision to stop all transmissions and switches off (i.e., the cognitive radio system ceases its service in vicinity of this basestation).

Alternatively, the second communication device may reduce its transmission power sufficiently such that its transmissions would not interfere with the signal transmissions of the nearby incumbent user transmission station.

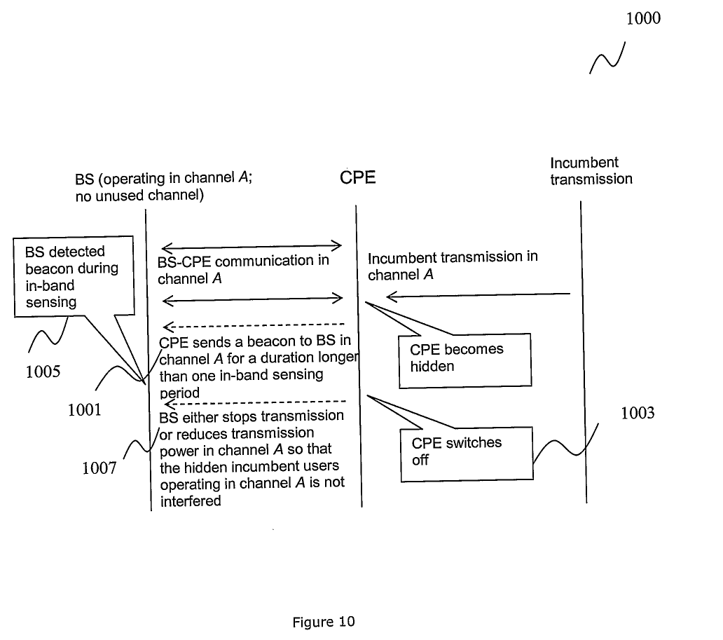

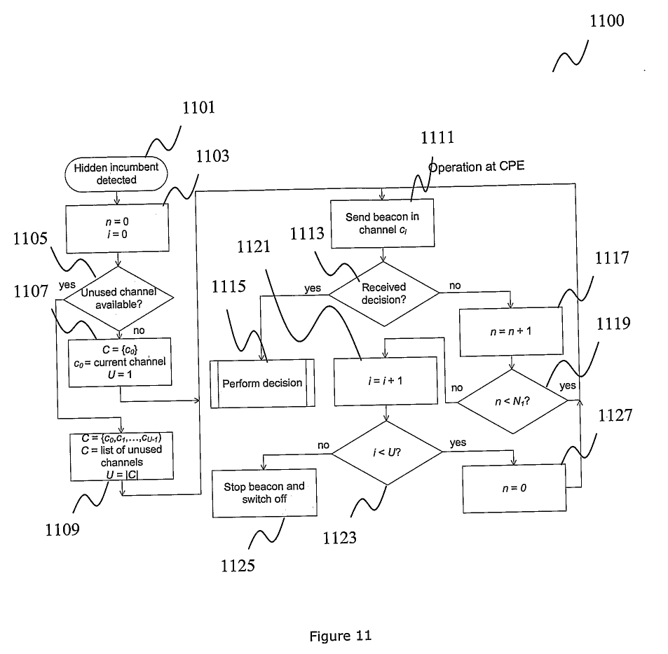

It can be seen that during the relatively short period when the beacon messages are transmitted at high transmission power levels, the amount of interference caused to both the incumbent users as well as the cognitive radio system is relatively high. In view of this, a variant of this embodiment is developed and will be discussed in relation to FIG. 10.

FIG. 10 shows a flow diagram 1000 describing a fourth embodiment of transmitting data and receiving data, according to one embodiment of the invention.

The scenario illustrated by FIG. 10 is similar to that illustrated in FIG. 9, whereby a cognitive radio system, comprising a first communication device and a second communication device, operates in frequency channel A, without any unused frequency channels, and the first communication device becomes affected due to the signal transmission of a nearby third communication device.

In this illustration, the first communication device may be, but is not limited to, a customer premise equipment, for example. The second communication device may be, but is not limited to, a basestation, for example. The third communication device may be, but is not limited to, an incumbent user transmission station, for example.

In this illustrative example of an embodiment of the invention, upon realizing that it is an affected customer premise equipment, the customer premise equipment first determines a list of the unused frequency channels, and finds that there is no unused frequency channels.

Next, in step 1001, the customer premise equipment generates a sensing report and then transmits it on its last known operating frequency channel, which in this case is frequency channel A, as beacon messages. The beacon messages described earlier in relation to FIG. 8, may also be used in this embodiment of the invention.

With regard to step 1001, the customer premise equipment transmits the beacon messages continuously for a predetermined duration. The predetermined duration should be at least slightly longer than the periodic in-band sensing interval of the basestation, so that the basestation is able to detect the beacon in at least one of the in-band sensing intervals. The power of the beacon message transmission should be at least substantially the same as that used for the normal signaling and data transmissions.

As a side note, the difference between this embodiment and the embodiment described in relation to FIG. 9 is that the transmission of the beacon message is carried out at near the maximum transmission power level in the embodiment described in relation to FIG. 9, whereas the transmission of the beacon message is carried out at near normal transmission power level in this embodiment.

Additionally, in step 1003, after transmitting the beacon message for the predetermined duration, the customer premise equipment then either stops all transmissions or switches off.

On the basestation's side, since the beacon message is sent in the operating channel, the basestation will detect this beacon message during its in-band sensing, as shown in step 1005.

In step 1007, as there is no more unused frequency channels, the basestation may make a decision to stop all transmissions and switches off (i.e., the cognitive radio system ceases its service in vicinity of this basestation).

Alternatively, the basestation may reduce its transmission power sufficiently such that its transmissions would not interfere with the signal transmissions of the third communication device nearby.

As a side remark, it can be seen that the basestation operates in the same manner in both the embodiments shown in FIGS. 9 and 10.

FIG. 11 shows a flow chart 1100 describing a second embodiment, a third embodiment and a fourth embodiment of transmitting data, according to one embodiment of the invention.

In step 1101, the customer premise equipment performs its sensing process. During the sensing process, the customer premise equipment detects a signal transmission by an incumbent user transmission station.

The customer premise equipment then performs an initialization to set the index to the number of beacon message transmission, n, and the index to the frequency channel on which the beacon message is transmitted, i, to the value of 0 (in step 1103).

In step 1105, the customer premise equipment determines if there are unused frequency channels available. This information may be obtained through the broadcast information in the signal transmissions received from the basestation earlier, or from the sensing process it had carried out earlier, for example.

If it is determined in step 1105 that no unused frequency channels are available, the customer premise equipment sets the number of frequency channels to transmit on, U, to the value of 1 (in step 1107). In this case, the only frequency channel to transmit on is last known operating frequency channel of the last known basestation, from which the customer premise equipment had received a broadcast. In other words, in this case, this frequency channel is the only frequency channel on the list of frequency channels to transmit on.

If it is determined in step 1105 that there are unused frequency channels available, the customer premise equipment sets the maximum number of frequency channels to transmit on, U, according to the number of frequency channels on the list of unused frequency channels it maintains (in step 1109).

In this case, the list of frequency channels to transmit on is the same as the list of unused frequency channels the customer premise equipment maintains.

In both cases, the customer premise equipment then generates the sensing report and proceeds to step 1111, where it transmits the beacon message, comprising the sensing report generated, on the first frequency channel on the list of frequency channels to transmit on.

In step 1113, the customer premise equipment next listens for a signal transmission from the basestation in response to the beacon message, on the same frequency channel on which the beacon message had been transmitted earlier.

If a signal is received from the basestation and the signal contains a decision (or a command) of the basestation in step 1113, the customer premise equipment then performs the necessary tasks according to the decision of the basestation (in step 1115).

If no signal is received from the basestation or the signal received from the basestation cannot be decoded (which means that a decision from the basestation is yet to be received) in step 1113, the customer premise equipment then proceeds to step 1117, where the index to the number of beacon message transmission, n, is increased by 1.

In step 1119, if the index to the number of beacon message transmission, n, is determined to be less than the predetermined number of beacon message transmissions, N₁, the customer premise equipment proceeds to step 1111 where it transmits the beacon message on the same frequency channel as the one on which the earlier beacon message was transmitted.

If the index to the number of beacon message transmission, n, is determined in step 1119, to be not less than the predetermined number of beacon message transmissions, N₁, the customer premise equipment proceeds to step 1121, where the index to the frequency channel on which the beacon message is transmitted, i, is increased by 1.

As a side note, step 1119 is basically used to determine whether the predetermined number of beacon message transmissions had been reached. If the predetermined number of beacon message transmissions had been reached, then the next beacon message should be transmitted on the next frequency channel on the list of frequency channels to transmit on, if necessary.

In step 1123, if the index to the frequency channel on which the beacon message is transmitted, i, is determined to be not less than the maximum number of frequency channels to transmit on, U, then the customer premise equipment stops transmitting the beacon message and switches off in step 1125.

In step 1123, if the index to the frequency channel on which the beacon message is transmitted, i, is determined to be less than the maximum number of frequency channels to transmit on, U, the customer premise equipment proceeds to step 1127, where the index to the number of beacon message transmission, n, is reset to 0. Next, the customer premise equipment proceeds to step 1111 where it transmits the beacon message on the next frequency channel on the list of frequency channels to transmit on.

As a side note, step 1123 is basically used to determine whether the maximum number of frequency channels to transmit the beacon messages on had been reached. If the maximum number of frequency channels to transmit the beacon messages on had not been reached yet, the next beacon message should then be transmitted on the next frequency channel on the list of frequency channels to transmit on.

Additionally, it can be seen that the customer premise equipment transmits N₁ beacon messages on each unused frequency channel, when available. The purpose of transmitting N₁ beacon messages on each unused frequency channel is to ensure that in each unused frequency channel, the basestation has the opportunity to detect and decode one of these beacon messages during its out-of-band sensing periods, and thus, is able to receive the sensing report of the customer premise equipment.

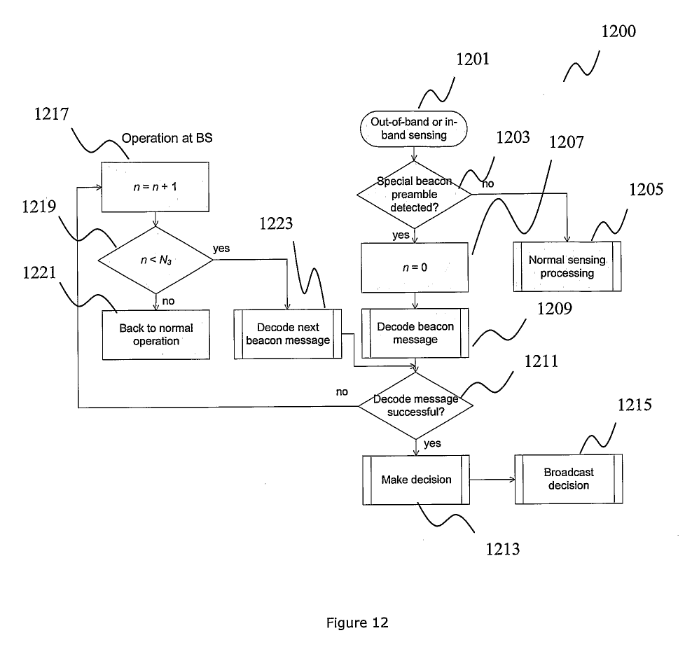

FIG. 12 shows a flow chart 1200 describing a second embodiment, a third embodiment and a fourth embodiment of receiving data, according to one embodiment of the invention.

In step 1201, the basestation performs its sensing process, for both out-of-band frequency channels as well as the in-band frequency channel. If a beacon message with the special predetermined preamble is not detected in step 1203, then the basestation then proceeds with its normal sensing processing (step 1205).

If the beacon message with the special predetermined preamble is detected in step 1203, the basestation then attempts to derive the sensing report in the beacon message. In step 1207, the index to the number of decoding tries, n, is set to the value of 0. In step 1209, the basestation attempts to decode the beacon message in order to derive the sensing report.

If the message decode is determined to be successful in step 1211, the basestation makes a decision regarding the cognitive radio system operated by it (in step 1213) and then broadcasts the decision made to the customer premise equipment in the cognitive radio system (in step 1215).

If the message decode is determined to be not successful in step 1211, the basestation then proceeds to step 1217, where the index to the number of decoding tries, n, is incremented by 1.

Next, the basestation determines whether the index to the number of decoding tries, n, is less than the predetermined maximum number of decoding tries, N₃. If it is determined that the index to the number of decoding tries, n, is not less than the predetermined maximum number of decoding tries, N₃, in step 1219, the basestation then proceeds to step 1221, where it will go back to its normal operation.

If it is determined that the index to the number of decoding tries, n, is less than the predetermined maximum number of decoding tries, N₃, in step 1219, the basestation proceeds to step 1223, where it waits and listens for the next beacon message in order to attempt another decode. Following which, the basestation determines whether the decoding of the next message is successful or not, in step 1211.

As a side note, it can be seen that the embodiment of receiving data corresponding to the second embodiment of transmitting data, may be also used in conjunction with the third embodiment and the fourth embodiment of transmitting data (see, for example, FIGS. 7, 9 and 10, respectively). In other words, the basestation only needs to determine the beacon message (either from the in-band frequency channel or the out-of-band frequency channels) and then derive the sensing report from the beacon message.

On the other hand, for the customer premise equipment, it has to first determine which embodiment of transmitting data should be selected for use in transmitting the beacon message. For example, in step 1105, if there are unused frequency channels available, then the second embodiment of transmitting data is selected. Otherwise, if it is determined that there are no unused frequency channels available, then either the third embodiment or the embodiment of transmitting data may be selected.

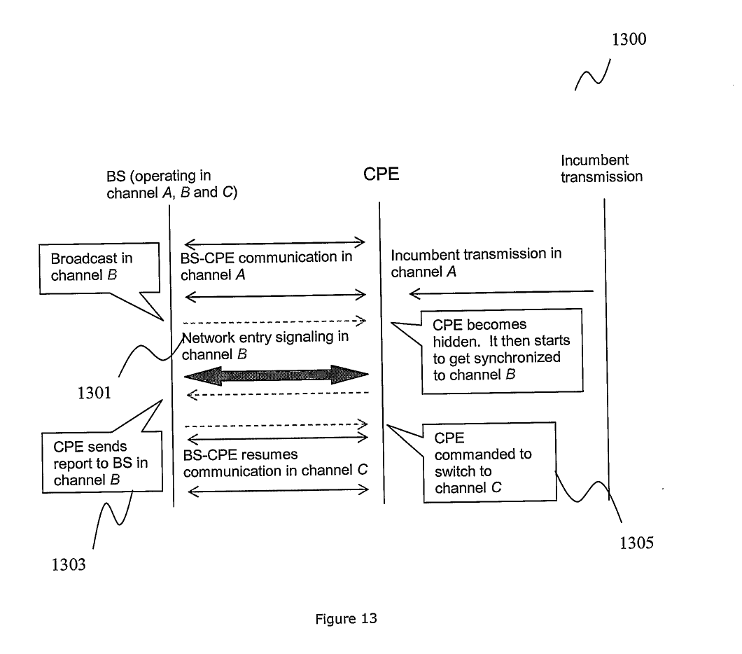

FIG. 13 shows a flow diagram 1300 describing a fifth embodiment of transmitting data and receiving data, according to one embodiment of the invention.

The scenario illustrated by FIG. 13 is similar to that illustrated in FIGS. 3 and 7, whereby a cognitive radio system, comprising a first communication device and a second communication device, operates in frequency channel A, with two frequency channels known to be unused, B and C, and the first communication device becomes affected due to the signal transmission of a nearby third communication device.

In this illustration, the first communication device may be, but is not limited to, a customer premise equipment, for example. The second communication device may be, but is not limited to, a basestation, for example. The third communication device may be, but is not limited to, an incumbent user transmission station, for example.

However, unlike the embodiments described in relation to FIGS. 3, 7, 9 and 10, the basestation in this embodiment also broadcasts control information, including a synchronization signal, in one of the known unused frequency channels (frequency channel B).

In this illustrative example of an embodiment of the invention, upon realizing that it is an affected customer premise equipment, the customer premise equipment first listens to frequency channel B, in order to determine the control information broadcasted by the basestation, including the synchronization signal.

Next, in step 1301, the customer premise equipment generates a sensing report and then attempts to synchronize with the basestation using the synchronization signal broadcasted on frequency channel B. Once synchronization with the basestation is achieved, the affected customer premise equipment then sends the sensing report generated to the basestation on frequency channel B, in step 1303.

After successfully receiving the sensing report and determining which frequency channel is affected by the incumbent user transmission station's signal transmissions, the basestation selects an unused frequency channel from a list of unused frequency channels maintained at the basestation. In this illustration, frequency channel C is selected.

Next, in order to switch all customer premise equipment operating in the current frequency channel to the selected frequency channel, (in step 1305) the basestation broadcasts a frequency channel switch command, for example, in the current frequency channel where it is operating in (frequency channel A), as well as the frequency channel on which the sensing report was received (frequency channel B). Subsequently, this cognitive radio system continues its operation on frequency channel C.

As a side remark, it can be seen that the embodiment described here is similar to the embodiment described in relation to FIG. 3, whereby the affected customer premise equipment in both these embodiments use the synchronization signal broadcasted by the basestation in another unused frequency channel, to first synchronize with the basestation before transmitting the sensing report.

As a side note, it can be seen that during the process of transmitting a sensing report by the affected customer premise equipment to the basestation, the basestation appears to only respond to the actions (or initiatives) of the affected customer premise equipment. Accordingly, given that there are five embodiments of transmitting data, the customer premise equipment must also make a decision on which of these to use.

In one exemplary embodiment, the customer premise equipment makes the decision on which embodiment of transmitting data to use based on last known operating parameters of the cognitive radio system.

If “channel bonding” were used in the cognitive radio system, then the fifth embodiment of transmitting data (see, for example, the illustration in FIG. 13) may be considered for use.

In this context, the term “channel bonding” refers to the use of more than one frequency channels by the basestation for data transmission. In this regard, the basestation also broadcasts control information in all the frequency channels used.

However, if “channel bonding” were not used in the cognitive radio system or if the control information were not found in this one other frequency channel, then the customer premise equipment may check the last known operating parameters of the cognitive radio system on whether the preferred mode of reporting is synchronous or asynchronous.

If the preferred mode of reporting were synchronous, then the first embodiment of transmitting data (see, for example, the illustration in FIG. 3) may be considered for use.

However, if the preferred mode of reporting were asynchronous, or after the transmission of the beacon signals, if no synchronizing signal or control information were detected on the unused frequency channels, then the customer premise equipment may determine whether there are unused frequency channels.

If there were unused frequency channels, then the second embodiment of transmitting data (see, for example, the illustration in FIG. 7) may be considered for use.

However, if there were no unused frequency channels, or if there were no response from the basestation after the transmission of the beacon messages, then the fourth embodiment of transmitting data (see, for example, the illustration in FIG. 10) may be considered for use first, prior to using the third embodiment of transmitting data (see, for example, the illustration in FIG. 9).

As a side remark, the embodiments of the invention have been described with reference to specific communication systems, for example. It should be understood by those skilled in the art that these embodiments may be used in wireless communication systems, such as cellular communication systems, for example. Examples of cellular communication systems include the systems according to GSM, FOMA, UMTS, CDMA2000 and 3GPP, for example.

Embodiments of the invention have the following advantages.

Firstly, it can be seen that the basestation is not required to continuously broadcast information in unused frequency channels, except for the embodiment discussed in relation to FIG. 13 where basestation continuously broadcast information in only one of the known unused frequency channels. Accordingly, more unused frequency channels are now available for other nearby cognitive radio systems to use for their data transmissions.

Secondly, it can be seen that the implementation of the embodiments of the invention does not require any hardware changes and only involves changes at the software level. Accordingly, the embodiments of the invention are thus easy to implement.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

In this document, the following publication is cited:
[1] IEEE 802.22 Working Group. IEEE P802.22/D0.1 Draft Standard for Wireless Regional Area Networks Part 22: Cognitive Wireless RAN Medium Access Control (MAC) and Physical Layer (PHY) specifications: Policies and procedures for operation in the TV Bands, May 2006.

What is claimed is:

1. A method of transmitting data from a first communication device to a second communication device, comprising:
receiving a first signal on a first frequency channel from the second communication device;
generating data, wherein the data comprises a reception status indicating whether there is interference on the first frequency channel due to a second signal transmitted by a third communication device;
transmitting a third signal on a second frequency channel to the second communication device, wherein the transmission is carried out for a predetermined duration;
receiving a fourth signal on the second frequency channel from the second communication device; and
transmitting the data generated on the second frequency channel to the second communication device.

2. The method of claim 1, wherein the third signal comprises a multi-tone signal.

3. The method of claim 1, further comprises
synchronizing to the fourth signal received on the second frequency channel from the second communication device.

4. The method of claim 3, wherein the fourth signal is a synchronization signal.

5. The method of claim 1, wherein the second communication device is a basestation.

6. A method of receiving data from a first communication device at a second communication device, comprising:
transmitting a first signal on a first frequency channel;
receiving a second signal on one of a plurality of frequency channels;
determining the frequency channel from which the second signal is received;
transmitting a third signal on the frequency channel determined; and
receiving data on the frequency channel determined, wherein the data comprises a reception status indicating whether there is interference on the first frequency channel due to a fourth signal transmitted by a third communication device.

7. The method of claim 6, wherein the third signal is a synchronization signal.

8. The method of claim 6, wherein the second communication device is a basestation.

9. A method of transmitting data from a first communication device to a second communication device, comprising:
receiving a first signal on a first frequency channel from the second communication device;
generating data, wherein the data comprises a reception status indicating whether there is interference on the first frequency channel due to a second signal transmitted by a third communication device; and
transmitting a third signal on a second frequency channel to the second communication device, wherein the third signal comprises the data generated, and wherein the transmission is carried out at predetermined intervals for a predetermined number of times.

10. The method of claim 9, wherein the third signal further comprises a preamble.

11. The method of claim 10, wherein the preamble is a pseudo-random sequence.

12. The method of claim 10, wherein the preamble is a Gold sequence.

13. The method of claim 9, wherein the second communication device is a basestation.

14. A method of transmitting data from a first communication device to a second communication device, comprising:
receiving a first signal on a first frequency channel from the second communication device;
generating data, wherein the data comprises a reception status indicating whether there is interference on the first frequency channel due to a second signal transmitted by a third communication device; and
transmitting a third signal on the first frequency channel to the second communication device, at a transmission power level at least substantially near the maximum transmission power level, wherein the third signal comprises the data generated.

15. The method of claim 14, wherein the transmission of the third signal is carried out for a predetermined duration.

16. The method of claim 14, wherein the third signal further comprises a preamble.

17. The method of claim 16, wherein the preamble is a pseudo-random sequence.

18. The method of claim 16, wherein the preamble is a Gold sequence.

19. The method of claim 14, wherein the second communication device is a basestation.

20. A method of transmitting data from a first communication device to a second communication device, comprising:
receiving a first signal on a first frequency channel from the second communication device;
generating data, wherein the data comprises a reception status indicating whether there is interference on the first frequency channel due to a second signal transmitted by a third communication device; and
transmitting a third signal on the first frequency channel to the second communication device, wherein the third signal comprises the data generated, and wherein the transmission is carried out for a predetermined duration.

21. The method of claim 20, wherein the third signal further comprises a preamble.

22. The method of claim 21, wherein the preamble is a pseudo-random sequence.

23. The method of claim 21, wherein the preamble is a Gold sequence.

24. The method of claim 20, wherein the second communication device is a basestation.

25. A method of receiving data from a first communication device at a second communication device, comprising:
transmitting a first signal on a first frequency channel;
determining a second signal from a plurality of frequency channels, wherein the second signal includes data, and wherein the data comprises a reception status indicating whether there is interference on the first frequency channel due to a third signal transmitted by a third communication device; and
deriving the data from the second signal determined.

26. The method of claim 25, wherein the second signal further comprises a preamble.

27. The method of claim 26, wherein the preamble is a pseudo-random sequence.

28. The method of claim 26, wherein the preamble is a Gold sequence.

29. The method of claim 25, wherein the second communication device is a basestation.

30. A method of transmitting data from a first communication device to a second communication device, comprising:
receiving a first signal on a first frequency channel from the second communication device;
generating data, wherein the data comprises a reception status indicating whether there is interference on the first frequency channel due to a second signal transmitted by a third communication device;
determining a third signal on the second frequency channel from the second communication device;
initiating the setting up of a communication connection with the second communication device on a second frequency channel;
determining a time interval for transmission allocated by the second communication device; and
transmitting the data generated on the second frequency channel to the second communication device, at a time interval allocated.

31. The method of claim 30, further comprises
synchronizing to the third signal received on the second frequency channel from the second communication device.

32. The method of claim 31, wherein the third signal is a synchronization signal.

33. The method of claim 30, wherein the second communication device is a basestation.

34. A method of receiving data from a first communication device at the second communication device, comprising:
transmitting a first signal on a first frequency channel;
transmitting a second signal on a plurality of second frequency channels;
setting up a communication connection initiated by a first communication device on one of the plurality of second frequency channels determined by the first communication device;
allocating a time interval for transmission by the first communication device on the frequency channel determined by the first communication device, wherein the allocation of the time interval for transmission is performed by the second communication device; and
receiving data from the first communication device at the time interval allocated on the frequency channel determined by the first communication device, wherein the data comprises a reception status indicating whether there is interference on the first frequency channel due to a third signal transmitted by a third communication device.

35. The method of claim 34, wherein the second signal is a synchronization signal.

36. The method of claim 34, wherein the second communication device is a basestation.
